(19) United States
(12) Patent Application Publication
(10) Pub. No.: US 2005/0084717 A1
(43) Pub. Date: Apr. 21, 2005

(54) Silicon carbide based porous structure and method for manufacturing thereof

(76) Inventors: Eiji Tani, Saga (JP); Kazushi Kishi, Saga (JP); Seiki Umebayashi, Saga (JP); Eishi Maeda, Saga (JP); Syuuji Tsunematsu, Saga (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/492,209

(22) PCT Filed: Oct. 22, 2002
(86) PCT No.: PCT/JP02/10917

(30) Foreign Application Priority Data
Oct. 22, 2001 (JP) 2001-322939
Jul. 15, 2002 (JP) 2002-205742

(51) Int. Cl. B32B 9/00

(52) U.S. Cl. 428/698

(57) ABSTRACT

A silicon carbide-based porous structure material maintaining the shape of a cardboard or sponge-like porous structure, with a great relative surface area, and a process for producing the same, is provided. To this end, a cardboard or sponge-like shaped framework of silicon carbide-based porous structure material is impregnated with a slurry comprising a resin, as a carbon source, and silicon powder, and subjected to reactive sintering in a vacuum or inert atmosphere, or in a nitrogen gas atmosphere, generating silicon carbide. At the same time pores are generated due to volume reduction reaction, thereby allows obtaining a silicon carbide-based porous structure material with a great relative surface area. Furthermore, excess carbon is removed from the fabricated silicon carbide-based porous structure material, and impregnated with a solution which becomes an oxide ceramic coating upon firing, whereby oxidization resistance is excellent and relative surface area is markedly improved.

### TECHNICAL FIELD

The present invention relates to a lightweight and heat resistant silicon carbide-based porous structural material having a honeycomb or sponge structure with interconnected pores, the material being produced by reaction sintering of silicon and carbon, or silicon and carbon and nitrogen, and also relates to a process for producing the material, and particularly relates to a lightweight and heat resistant silicon carbide-based porous structural material having a great relative surface area and accordingly being suitable for application to high-temperature catalyst carriers, high-temperature filters, high-temperature humidifying filters, filters for molten metal, sound absorbers, and so forth, and also relates to a process for producing the material.

### BACKGROUND ART

Silicon carbide and silicon nitride ceramics are light in weight and excellent in heat resistance, abrasion resistance, corrosion resistance, and so on, and accordingly, have in recent years been used in various applications such as high-temperature corrosion-resistant members, heater members, abrasion-resistant members, abrasives, and grindstones. Since the silicon carbide and silicon nitride ceramics are principally produced by sintering or melt-inclusion of silicon, this necessitates mold-forming techniques, sintering aids and temperatures of 1600° C. or higher, or vacuum containers for melt-inclusion, requiring special equipment.

In recent years, research of such heat-resistant lightweight porous ceramics has been started. For example, Bridgestone Corporation has attempted to produce a porous silicon carbide structure used for ceramic foam filters for molten metals according to the procedures of a sponge being impregnated with silicon carbide slurry, excess slurry being removed, dried, and then fired (see ceramic foam technical document No. 2 in Catalogue S-023 of the corporation). Also, Tokai Carbon Co., Ltd. is attempting to use porous silicon carbide-based structural materials, obtained with similar techniques, as heaters (see “Porous Silicon Carbide Heaters”, Yoshiaki Mizuno, Ceramics vol. 33, No. 7, p534-537 (1998)).

However, with this method, the porous structure is formed by the ceramic powder which has adhered to the framework of the sponge by impregnation being sintered, and accordingly, the slurry needs to thickly adhere to the sponge framework in order to prevent cracking or collapse of the formed article during drying and firing. Consequently, the diameter of openings of the sponge becomes smaller, inevitably enabling formation of only porous structures with high density, and there is a further shortcoming in that formation of the framework of the porous structure itself becomes difficult with opening diameter of a certain level or smaller.

Also, while silicon carbide based ceramics with a honeycomb shape are being manufactured with extrusion formation, but the molding machine and mold thereof are expensive, and there is also the problem that the form is determined by the mold.

The present inventor has discovered in the research of fiber-reinforced silicon carbide composite material that the silicon carbide generating reaction between carbon from resin and silicon powder is accompanied by reduction in volume, exhibiting good adhesion with the fiber (see Japanese Examined Patent Application Publication No. 7-84344). The present inventor has further discovered, based thereupon, that impregnating a porous material such as cardboard or sponge or the like with a slurry of phenol resin and silicon powder, and then performing melt-inclusion of silicon following the reactive sintering, enables a silicon carbide based heat-resistant and lightweight porous structure material with fine framework portions and a small relative surface area (see Japanese Unexamined Patent Application Publication No. 2001-226174). However, heat-resistant and lightweight porous structure material with a particularly great relative surface area is suitable for the aforementioned usages such as high-temperature catalyst carriers, high-temperature filters, high-temperature humidifying filters, filters for molten metal, sound absorbers, and so forth, and accordingly, development of a porous structure material which has sufficient strength to withstand machining but also has sufficiently great relative surface area has been awaited.

### DISCLOSURE OF INVENTION

The present invention has been made in light of the above-described, and accordingly, it is an object of the preset invention to overcome the various shortcomings of the conventional silicon carbide-based porous structural materials and the processes for producing the same, and to provide a silicon carbide-based porous structural material with a great relative surface area which can be readily produced even in the event of retaining the form of the framework of the porous structure material with the framework having a porous and complicated form as well, and also to provide a low-cost process for producing the material.

It is another object of the present invention to further increase the relative surface area of the silicon carbide-based porous structural material so as to protect the framework of the silicon carbide, and provide a silicon carbide-based porous structural material which has been provided with oxidation resistance an so forth, and also to provide a process for producing the material.

That is to say, as a result of diligent research regarding silicon carbide-based porous structural materials, the present inventor has discovered that impregnating a shaped framework of a porous structure such as cardboard or sponge or the like with silicon powder and resin and firing this in a vacuum or an inert atmosphere such as argon or the like, enables producing a silicon carbide heat-resistant lightweight porous structure material, having a great relative surface area retaining a shaped framework of the porous structure, to be easily produced even in the event that the shape is complicated, due to the porous silicon carbide generating reaction between the silicon powder and the carbon from the above-described structure which exhibits reduction in volume.

It has also been discovered that firing the carbonized porous structure in a nitrogen gas atmosphere causes a part of the silicon powder to become silicon nitride, thereby yielding a mixture of silicon nitride and porous silicone carbide.

Further, in a case of using the silicon carbide-based porous structural material as a high-temperature catalyst carrier, it has been found that silicon carbide has poor compatibility with the catalyst to be carried, and in order to realize good carrying, the surface thereof is rather preferably an oxide ceramic. Accordingly, this point needs to be improved in order to enable further widespread use as high-temperature catalyst carriers and high-temperature filters.

In order to solve this problem as well, the present inventor has discovered that thinly coating the entire surface of the very uneven porous structure with an oxide ceramic having an even greater relative surface area enables marked improvement in the relative surface area thereof, and in a case of use in an oxidizing atmosphere, this serves as an oxidization barrier to protect the framework of silicon carbide, and further, the strength of the structure itself also increases since it is covered with a strong oxide ceramic skin.

In brief, the silicon carbide-based porous structure material according to the present invention which has been completed as described above is composed of a sintered body of a porous structure in which pores are generated in the framework portion due to volume reduction reaction, and is formed by reactive sintering by impregnating a porous structure having the shaped framework such as paper, carbon, plastic, or the like, with a slurry containing resin serving as a carbon source and silicon powder.

With a process for producing a silicon carbide-based porous structure material according to the present invention, a porous structure having a shaped framework retaining the shape of a cardboard or sponge-like article, is impregnated with a slurry containing a resin serving as a carbon source and silicon powder is subsequently carbonized in a vacuum or argon atmosphere or the like at a temperature of 900 to 1300° C., and then the carbonized porous structure is subjected to reactive sintering in a vacuum or argon atmosphere or the like at a temperature of 1300° C. or higher, thereby generating silicon carbide, and simultaneously generating pores at the framework portion thereof due to a volume reduction reaction.

Firing the above porous structure in a nitrogen gas atmosphere results in carbonization at 900 to 1000° C., and a part of the silicon powder becomes silicon nitride at 1000° C. and above, which can be made into a mixture with porous silicon carbide.

The excess silicon may be left remaining in the porous structure obtained by reactive sintering, or in the event that carbon remains this can be removed by firing at 500° C. or above in the atmosphere.

According to the process of the present invention, large structures of complicates shapes can be readily produced, and working of the porous structure can be easily performed following carbonization.

Also, the silicon carbide-based porous structure material may be formed by excess carbon therein being removed in pre-firing in air, and the silicon carbide-based porous structure material being impregnated with a solution which becomes an oxide ceramic by firing, to which has been added one or both of: a slurry in which has been suspended inorganic powder of ceramic or metal or the like to serve as a second component; and a solution including a soluble salt of a substance to become a second component following firing; which is fired, thereby covering the silicon carbide-based porous structure material with an oxide ceramic, and in this case, the entire surface of the very uneven silicon carbide-based porous structure is coated with an oxide ceramic having an even greater relative surface area, which enables improved oxidization resistance and marked improvement in the relative surface area thereof, and in a case of use of the structure in an oxidizing atmosphere in particular, the oxide ceramic film serves as an oxidization barrier, which is effective in protecting the framework of silicon carbide. Also, the strength of the structure itself also increases since the silicon carbide-based porous structure material is covered with a strong oxide ceramic skin.

To produce the silicon carbide-based porous structure material covered with the oxide ceramic, excess carbon in the silicon carbide-based porous structure material produced as described above is removed in pre-firing in air, and the silicon carbide-based porous structure material is impregnated with a solution which becomes an oxide ceramic by firing, which is fired, thereby covering the silicon carbide-based porous structure material with an oxide ceramic.

Also, following excess carbon being removed in pre-firing in air in the same way, the silicon carbide-based porous structure material may be impregnated with a solution which becomes an oxide ceramic by firing, to which has been added one or both of: a slurry in which has been suspended inorganic powder of ceramic or metal or the like to serve as a second component; and a solution including a soluble salt of a substance to become a second component following firing; which is fired, thereby covering the silicon carbide-based porous structure material with an oxide ceramic.

As for the solution which becomes an oxide ceramic by firing used in the above-described processes, one or a combination of an aluminum hydroxide sol aqueous solution, a titanium hydroxide sol aqueous solution, and a silica sol aqueous solution, is suitable.

As for the shaped framework of the porous structure used in the above-described processes, a porous structure capable of holding the slurry is preferable, and paper such as cardboard or boxboard, a carbon cardboard or plate-shaped material, wood, woven cloth, non-woven cloth, or sponge-like or sheet-shaped porous plastic, are suitable for the material making up the shaped framework of the porous structure.

Also, in the above-described processes, suitable examples of the resin serving as the carbon source with which the shaped framework of the porous structure is impregnated include phenol resin, furan resin, organic metal polymer such as polycarbosilane, and pitch. One of these resins may be used, or two or more may be combined and used. Further, carbon powder, graphite, or Carbon Black, may be added as an additive, and one or more selected from silicon carbide, silicon nitride, zirconia, zircon, alumina, silica, mullite, molybdenum bisilicate, boron carbide, and boron, may be added as an aggregate or an oxidization inhibitor.

As for the silicon powder to be included in the slurry used in the above-described processes, a silicon alloy of at least one type selected from magnesium, aluminum, titanium, chromium, manganese, iron, cobalt, nickel, copper, zinc, zirconium, niobium, molybdenum, or tungsten, or a mixture of at least one type thereof and silicon powder, may be used.

### BEST MODE FOR CARRYING OUT THE INVENTION

Next, suitable examples of the producing processes according to the present invention and the porous structure material obtained thereby will be described.

With the process according to the present invention, first, a slurry formed by mixing a phenol resin or the like serving as a dissolved carbon source with silicon powder is sufficiently coated on a shaped framework of a porous structure, or the porous structure is immersed in the slurry so as to be impregnated therewith, and then dried. Drying is preferably carried out over around 12 hours at approximately 70° C.

As for the shaped framework of the porous structure, as described above, paper such as cardboard or boxboard, a carbon cardboard or plate-shaped material, wood, woven cloth, non-woven cloth, or sponge-like or sheet-shaped porous plastic, can be used.

Also, as the resin with which the shaped framework of the porous structure is impregnated, at least one selected from phenol resin, furan resin, organic metal polymer, and pitch, can be used, and further, carbon powder, graphite, or Carbon Black, may be added as an additive, as necessary.

Further, fine powder is suitable for the above silicon powder used in generating silicon carbide, and fine powder with an average grain diameter of 30 μm or smaller is particularly suitable. Powder with a great grain diameter can be made into fine powder by pulverizing with a ball mill or the like.

Next, the porous structure obtained thus is carbonized at a temperature of around 900 to 1300° C. in a vacuum or an inert atmosphere of argon or the like. The porous structure may also be carbonized in a nitrogen gas atmosphere, and in this case is carbonized at a temperature around 900 to 1000° C. With the carbonized complex obtained thereby, the porous structure has been thermally decomposed, and the framework portion is in a state wherein a carbon portion of inorganic material containing carbon following thermal decomposition and phenol resin that has been carbonized is mixed with silicon powder, so the shape of the framework portion is almost the same as the original shape. Also, the carbonized porous structure has sufficient strength to be machined.

The carbonized porous structure is subjected to firing at a temperature of 1300° C. or higher in a vacuum or an inert atmosphere such as argon or the like, so as to cause the carbon and the silicon to react and to form silicon carbide on the shaped framework portion of the structure. At the same time, this reaction is a volume reduction reaction, so pores due to the volume reduction reaction are formed. As a result, a sintered body of a porous structure, wherein a matrix portion is formed of silicon carbide having pores, is obtained.

Also, in the event of firing under a nitrogen gas atmosphere, a part of the silicon generates silicon nitride at temperatures of 1000° C. and higher, yielding a mixture of silicon nitride and silicon carbide which has pores. In the event that there is residual carbon, this can be oxidized and removed.

The ratio of mixing the silicon powder and the carbon from the resin to be used with the process according to the present invention is preferably selected so that the atomic ratio of silicon and carbon is Si/C=0.1 to 5.

Next, the method for coating the silicon carbide-based porous structure material produced with the above method, with an oxide ceramic, will be described.

The silicon carbide-based porous structure material manufactured with the above-described method is subjected to both carbonization and firing in a vacuum or an inert atmosphere such as argon or the like, and accordingly there is often residual unreacted carbon, but in the event of coating with the oxide ceramic, this excessive carbon needs to be oxidized and eliminated beforehand by pre-firing the silicon carbide-based porous structure material in the air, since this carbon may react with the oxygen in the atmosphere or the oxide, adversely affecting the coating.

The processing for removing this carbon generates new pores and increases the relative area of the framework of the porous structure material, and also the surface of the silicon carbide is oxidized and becomes silica, which is advantageous in that adhesion of the oxide ceramic to be coated is facilitated.

In a case of using cardboard or the like as the shaped framework, calcium or other non-organic substances may be included therein as filler, but such substances remain as ash even after carbonization and firing. In the event that such ash may lower the properties of the ceramic to serve as the coating, this is preferably removed beforehand by a suitable method, such as washing with hydrochloric acid or the like.

Following removing the excessive carbon from the silicon carbide-based porous structure material in this way, the silicon carbide-based porous structure material is impregnated with the solution which becomes an oxide ceramic by firing, to which has been added one or both of: a slurry in which has been suspended inorganic powder of ceramic or metal or the like to serve as a second component; and a solution including a soluble salt of a substance to become a second component following firing; which is fired, thereby covering the silicon carbide-based porous structure material with an oxide ceramic.

As for the solution which becomes an oxide ceramic by firing in the above-described processes, one or a combination of an aluminum hydroxide sol aqueous solution, a titanium hydroxide sol aqueous solution, and a silica sol aqueous solution, may be used. Impregnation may be carried out at any concentration of the aluminum hydroxide sol aqueous solution, titanium hydroxide sol aqueous solution, silica sol aqueous solution, etc., but in the event that the solution is diluted too much, effects of increase relative surface area and the like are poor, and in the event that the concentration is too high, the solution adheres too thickly to the porous structure material framework, leading to cracking of the film at the time of drying, so while the concentration differs according to the type of hydroxide solution, generally 0.5 to 50 percent by weight, in terms of conversion into the oxide, is preferable.

As for the aluminum hydroxide sol aqueous solution in he above-described processes, titanium hydroxide sol aqueous solution, and silica sol aqueous solution, aqueous solutions respectively obtained by hydrolysis of aluminum alcoxide, titanium alcoxide, and alkyl silicate, may be used.

Also, while there is no particular restriction on the inorganic powder serving as the second component to be used by being mixed into the aluminum hydroxide sol aqueous solution, titanium hydroxide sol aqueous solution, silica sol aqueous solution, etc., substances generally used for heat-resistant ceramics, such as alumina, mullite, zirconia, silicon nitride, silicon carbide, and so forth for example, or a mixture of two or more thereof may be used, and further, powder serving as a sintering aid, grain growth suppressant, etc., such as yttria, magnesia, etc., may be mixed in at the same time.

Examples of the soluble salt of a substance to become the second component after firing include magnesium, yttrium, etc., and like nitrates, haloids, and so forth.

While simply immersing the suitably-formed silicon carbide structure material in a solution is sufficient for impregnation of the porous silicon carbide structure material with the aluminum hydroxide sol aqueous solution, titanium hydroxide sol aqueous solution, silica sol aqueous solution, etc., in a case that impregnation with large or irregularly-shaped members with a high level of surety is desired, using a decompressed container is preferable.

Subsequently, the silicon carbide-based structure material which has been fired and impregnated with the solution to become an oxide ceramic is fired, thereby yielding the silicon carbide porous structure material coated with the oxide ceramic.

With the silicon carbide porous structure material coated with the oxide ceramic that has been produced in this way, the entire very uneven surface of the silicon carbide-based porous structure material is coated with the oxide ceramic having an even greater relative surface area, which not only enables improved oxidization resistance but also marked improvement in the relative surface area thereof.

In a case of use of the structure in an oxidizing atmosphere, the oxide ceramic film serves as an oxidization barrier, which is effective in protecting the framework of silicon carbide. Further, the strength of the structure itself also increases since the silicon carbide-based porous structure material is covered with a strong oxide ceramic skin.

With the silicon-carbide-based porous structure material and the production process thereof according to the present invention, described in detail above, a shaped framework of a porous structure is impregnated with a slurry including resin serving as a carbon source and silicon powder to an extent that the continuous pores of the porous structure are not clogged, and silicon carbide or silicon nitride containing pores is generated at the frame work portion using reactive sintering so as to maintain the original shape of the porous structure, enables producing a silicon carbide-based porous structure material which has sufficiently great relative surface area and also has strength sufficient for machining, at low costs, and accordingly, even complicated-shaped articles can be produced easily, thereby yielding heat-resistant light weight porous structure materials suitable for many usages, such as high-temperature catalyst carriers, high-temperature filters, high-temperature humidifying filters, filters for molten metal, sound absorbers, and so forth.

Also, thinly coating the oxide ceramic with the even greater relative surface area on the silicon carbide porous structure having pores generated at the framework portion due to the volume reduction reaction allows the usages of the heat-resistant light weight porous structure material to be broadened even further.

### EXAMPLES

Next, the process according to the present invention will be described in further detail by way of examples, but it should be noted that the present invention is in no way restricted by these examples.

### Example 1

The mixture amount of the phenol resin and the silicon powder was set at a ratio such that the atomic ratio of the carbon from carbonization of phenol resin and the silicon was 2:3, the phenol resin was dissolved in ethyl alcohol to prepare a slurry, mixed in a ball mill for one day to reduce the grain diameter of the silicon, pasted layered cardboard was impregnated therewith, and then dried.

Next, the cardboard was carbonized by firing for one hour in an argon atmosphere at 1000° C. The obtained carbon porous material was subjected to reactive sintering for one hour in an argon atmosphere at 1450° C., thereby obtaining a silicon carbide-based heat resistance and lightweight porous composite material having the same shape as that of the cardboard.

The obtained silicon carbide-based heat resistance and lightweight porous structure material had the same structure as the cardboard, and was extremely small, having relative surface area of 2.4 m²/g, and density of 0.13 g/cm³, but had sufficient strength for machining.

### Example 2

The mixture amount of the phenol resin and the silicon powder was set at a ratio such that the atomic ratio of the carbon from carbonization of phenol resin and the silicon was 2:3, the phenol resin was dissolved in ethyl alcohol to prepare a slurry, mixed in a ball mill for one day to reduce the grain diameter of the silicon, pasted layered cardboard was impregnated therewith, and then dried.

Next, the cardboard was carbonized by firing for one hour in an argon atmosphere at 1000° C. The obtained carbon porous material was subjected to reactive sintering for one hour in a nitrogen atmosphere at 1450° C., thereby obtaining a heat resistance and lightweight porous composite material containing silicon carbide and silicon nitride having the same shape as that of the cardboard. The obtained porous structure material was greenish and had the same structure as the cardboard, and was extremely small, having relative surface area of 5.3 m²/g, and density of 0.15 g/cm³, but had sufficient strength for machining.

### Example 3

Phenol resin and silicon were measured at a ratio such that the atomic ratio of the carbon from carbonization of phenol resin and the silicon was 2:3, and ethyl alcohol was added thereto and mixed in a ball mill for 20 hours. A tri-layered cardboard piece formed to approximately 10 by 10 by 50 mm was immersed in this slurry, and then blow-dried for 18 hours. The dried article was carbonized at 1000° C. in an argon atmosphere, following which the temperature was raised to 1450° C. in a vacuum and held, where reactive sintering was performed, thereby obtaining a silicon carbide porous structure material.

Separately from this, 16 g of aluminum isopropoxide was added to approximately 100 ml of boiled distilled water and heated for one hour to effect hydrolysis, the isopropanol was removed therefrom and concentrated to approximately 50 ml, and then chilled. Diluted hydrochloric acid was added to the chilled solution and adjusted to pH 3, and then stirred for 20 hours so as to be deflocculated, thereby obtaining an aluminum hydroxide sol aqueous solution. The porous silicon carbide structure fabricated earlier was heated at 1000° C. in the air for one hour to remove excess carbon, and then immersed in this aluminum hydroxide sol aqueous solution so as to be impregnated with aluminum hydroxide. The impregnated article was dried for 24 hours at 80° C., and then heated to 300° C. in the air for one hour, thereby forming an alumina coating on he surface of the porous structure material. The relative surface area of the obtained porous structure was 55.8 m²/g, exhibiting an approximately 20-fold increase over the 2.4 m²/g of the original porous structure and the 2.9 m²/g of the article following only pre-firing.

### Example 4

10.5 g of titanium isopropoxide was gradually added to approximately 100 ml of distilled water while stirring to effect hydrolysis. The cloudy fluid following hydrolysis was heated to remove the isopropanol, and concentrated to approximately 50 ml and then chilled. Diluted hydrochloric acid was added to the chilled solution and adjusted to pH 3, and then stirred for 20 hours so as to be deflocculated, thereby obtaining a titanium hydroxide sol aqueous solution.

The porous silicon carbide-based structure material from which the excess carbon was removed in the same way as with Example 3 was then immersed in this solution so as to be impregnated with titanium hydroxide. The impregnated article was dried for 24 hours at 80° C., and then heated to 500° C. in the air for two hours, thereby forming titanium oxide coating on the surface of the porous structure material. The weight of the porous structure material following removal of the carbon was 0.701 g, and the weight following impregnation of titanium hydroxide and firing was 0.869 g, meaning that the structure material was coated with titanium oxide film of 0.17 g in weight.

### Example 5

14.0 g of ethyl silicate was gradually added to approximately 100 ml of diluted hydrochloric acid of pH 3, and stirred until the oil phase of the ethyl silicate completely disappeared to effect hydrolysis. The solution following hydrolysis was heated, concentrated to approximately 50 ml, and then chilled, yielding a silica sol aqueous solution. The silicon carbide-based porous structure material from which the excess carbon was removed in the same way as with Example 3 was then immersed in this solution so as to be impregnated with silica sol. The impregnated article was dried for 24 hours at 80° C., and then heated to 800° C. in the air for two hours, thereby forming a silica coating on the surface of the porous structure material. The weight of the porous structure material following removal of the carbon was 0.842 g, and the weight following impregnation of silica sol and firing was 0.966 g, meaning that the structure material was coated with silica film of 0.12 g in weight.

### Comparative Example 1

The mixture amount of the phenol resin and the silicon powder was set at a ratio such that the atomic ratio of the carbon from carbonization of phenol resin and the silicon was 5:4, the phenol resin was dissolved in ethyl alcohol to prepare a slurry, mixed in a ball mill for one day to reduce the grain diameter of the silicon, pasted layered cardboard was impregnated therewith, and then dried.

Next, the cardboard was carbonized by firing for one hour in an argon atmosphere at 1000° C. The obtained carbon porous material was subjected to reactive sintering for one hour in an argon atmosphere at 1450° C., and at the same time, melt-inclusion of silicon was carried out, thereby obtaining a silicon carbide-based heat resistance and lightweight porous composite material having the same shape as that of the cardboard.

The obtained silicon carbide-based heat resistance and lightweight porous structure material had the same structure as the cardboard, the relative surface area was small at 0.27 m²/g, and the density was somewhat high at 0.5 g/cm³, and had high strength.

1-13. (canceled)

14. A silicon carbide-based porous structure material comprising a silicon carbide-based porous structure in which are formed pores due to a volume-reduction reaction in the generation of silicon carbide by silicon and carbon reacting;
wherein said silicon carbide-based porous structure is
a porous structure having a shaped framework retaining the shape of inorganic material remaining following firing in a vacuum or an inert atmosphere, or
a porous structure subject to thermal decomposition following firing in a vacuum or an inert atmosphere, which is impregnated with a slurry comprising a resin serving as a carbon source and silicon powder and then the carbon and silicon powder are subjected to reactive sintering.

15. A silicon carbide-based porous structure material comprising
a silicon carbide-based porous structure comprising silicon carbide in which are formed pores due to a volume-reduction reaction in the generation of silicon carbide by silicon and carbon reacting, and silicon nitride generated by silicon and nitrogen reacting;
wherein said silicon carbide-based porous structure is
a porous structure having a shaped framework retaining the shape of inorganic material remaining following firing in a vacuum or an inert atmosphere, or
a porous structure subject to thermal decomposition following firing in a vacuum or an inert atmosphere, which is impregnated with a slurry containing a resin serving as a carbon source and silicon powder and then the carbon and silicon powder are subjected to reactive sintering in a nitrogen atmosphere.

16. A silicon carbide-based porous structure material according to claim 14,
wherein excess carbon in said silicon carbide-based porous structure material is removed in pre-firing in air,
and said silicon carbide-based porous structure material is covered with an oxide ceramic obtained by impregnating with a solution which becomes an oxide ceramic by firing, and firing.

17. A silicon carbide-based porous structure material according to claim 15,
wherein excess carbon in said silicon carbide-based porous structure material is removed in pre-firing in air,
and said silicon carbide-based porous structure material is covered with an oxide ceramic obtained by impregnating with a solution which becomes an oxide ceramic by firing, and firing.

18. A silicon carbide-based porous structure material according to claim 16, wherein the solution which becomes an oxide ceramic by firing further comprises a slurry comprising suspended inorganic powder of ceramic or metal to serve as a second component and/or a solution comprising a soluble salt of a substance to become a second component following firing.

19. A silicon carbide-based porous structure material according to claim 17, wherein the solution which becomes an oxide ceramic by firing further comprises a slurry comprising suspended inorganic powder of ceramic or metal to serve as a second component and/or a solution comprising a soluble salt of a substance to become a second component following firing.

20. A process for producing a silicon carbide-based porous structure material, wherein
a porous structure having a shaped framework retaining the shape of inorganic material remaining following firing in a vacuum or an inert atmosphere, or
a porous structure subject to thermal decomposition following firing in a vacuum or an inert atmosphere, is impregnated with a slurry comprising a resin serving as a carbon source and silicon powder
is subsequently carbonized in a vacuum or inert atmosphere at a temperature of 900 to 1300° C.
and then the carbonized porous structure is subjected to reactive sintering in a vacuum or inert atmosphere at a temperature of 1300° C. or higher, thereby generating silicon carbide, and
simultaneously generating pores due to a volume reduction reaction.

21. A process for producing a silicon carbide-based porous structure material, wherein
a porous structure having a shaped framework retaining the shape of inorganic material remaining following firing in a vacuum or an inert atmosphere, or
a porous structure subject to thermal decomposition following firing in a vacuum or an inert atmosphere, is impregnated with a slurry comprising a resin serving as a carbon source and silicon powder is subsequently carbonized in a vacuum or inert atmosphere at a temperature of 900 to 1000° C.,
and then the carbonized porous structure is subjected to reactive sintering in a nitrogen gas atmosphere at a temperature of 1000° C. or higher, thereby generating silicon carbide and silicon nitride, and
simultaneously generating pores due to a volume reduction reaction.

22. A process for producing a silicon carbide-based porous structure material, wherein excess carbon in a silicon carbide-based porous structure material produced with the process according to claim 20 is removed in pre-firing in air;
following which said silicon carbide-based porous structure material is covered with an oxide ceramic, by impregnating with a solution which becomes an oxide ceramic by firing, and firing.

23. A process for producing a silicon carbide-based porous structure material, wherein excess carbon in a silicon carbide-based porous structure material produced with the process according to claim 21 is removed in pre-firing in air;
following which said silicon carbide-based porous structure material is covered with an oxide ceramic, by impregnating with a solution which becomes an oxide ceramic by firing, and firing.

24. A process for producing a silicon carbide-based porous structure material, wherein excess carbon in a silicon carbide-based porous structure material produced with the process according to claim 20 is removed in pre-firing in air;
and said silicon carbide-based porous structure material is impregnated with a solution which becomes an oxide ceramic by firing further comprising
a slurry comprising suspended inorganic powder of ceramic or metal to serve as a second component; and
a solution comprising a soluble salt of a substance to become a second component following firing;
which is fired, thereby covering said silicon carbide-based porous structure material with an oxide ceramic.

25. A process for producing a silicon carbide-based porous structure material wherein excess carbon in a silicon carbide-based porous structure material produced with the process according to claim 21 is removed in pre-firing in air;
and said silicon carbide-based porous structure material is impregnated with a solution which becomes an oxide ceramic by firing further comprising
a slurry comprising suspended inorganic powder of ceramic or metal to serve as a second component; and
a solution comprising a soluble salt of a substance to become a second component following firing;
which is fired, thereby covering said silicon carbide-based porous structure material with an oxide ceramic.

26. A process for producing a silicon carbide-based porous structure material according to claim 22, wherein said solution which becomes an oxide ceramic by firing is an aluminum hydroxide sol aqueous solution, a titanium hydroxide sol aqueous solution, a silica sol aqueous solution or mixtures thereof.

27. A process for producing a silicon carbide-based porous structure material according to claim 23, wherein said solution which becomes an oxide ceramic by firing is an aluminum hydroxide sol aqueous solution, a titanium hydroxide sol aqueous solution, a silica sol aqueous solution or mixtures thereof.

28. A process for producing a silicon carbide-based porous structure material according to claim 26, wherein said aluminum hydroxide sol aqueous solution, titanium hydroxide sol aqueous solution, and silica sol aqueous solution, are aqueous solutions respectively obtained by hydrolysis of aluminum alcoxide, titanium alcoxide, and alkyl silicate.

29. A process for producing a silicon carbide-based porous structure material according to claim 27, wherein said aluminum hydroxide sol aqueous solution, titanium hydroxide sol aqueous solution, and silica sol aqueous solution, are aqueous solutions respectively obtained by hydrolysis of aluminum alcoxide, titanium alcoxide, and alkyl silicate.

30. A process for producing a silicon carbide-based porous structure material according to claim 20, wherein the material making up the shaped framework of the porous structure comprises a cardboard or boxboard, a carbon cardboard or plate-shaped material, wood, woven cloth, non-woven cloth, or sponge-like or sheet-shaped porous plastic.

31. A process for producing a silicon carbide-based porous structure material according to claim 21, wherein the material making up the shaped framework of the porous structure comprises a cardboard or boxboard, a carbon cardboard or plate-shaped material, wood, woven cloth, non-woven cloth, or sponge-like or sheet-shaped porous plastic.

32. A process for producing a silicon carbide-based porous structure material according to claim 20, wherein the resin, with which the shaped framework of the porous structure is impregnated, comprises at least phenol resin, furan resin, organic metal polymer, or pitch.

33. A process for producing a silicon carbide-based porous structure material according to claim 21, wherein the resin, with which the shaped framework of the porous structure is impregnated, comprises at least phenol resin, furan resin, organic metal polymer, or pitch.

34. A process for producing a silicon carbide-based porous structure material according to claim 20, wherein the slurry, with which the shaped framework of the porous structure is impregnated, further comprises carbon powder, graphite, or Carbon Black, as an additive.

35. A process for producing a silicon carbide-based porous structure material according to claim 21, wherein the slurry, with which the shaped framework of the porous structure is impregnated, further comprises carbon powder, graphite, or Carbon Black, as an additive.

36. A process for producing a silicon carbide-based porous structure material according to claim 20, wherein the slurry, with which the shaped framework of the porous structure is impregnated, further comprises at least one type of powder selected from silicon carbide, silicon nitride, zirconia, zircon, alumina, silica, mullite, molybdenum bisilicate, boron carbide, and boron, as an aggregate or an oxidization inhibitor.

37. A process for producing a silicon carbide-based porous structure material according to claim 21, wherein the slurry, with which the shaped framework of the porous structure is impregnated, further comprises at least one type of powder selected from silicon carbide, silicon nitride, zirconia, zircon, alumina, silica, mullite, molybdenum bisilicate, boron carbide, and boron, as an aggregate or an oxidization inhibitor.

38. A process for producing a silicon carbide-based porous structure material according to claim 20, wherein a silicon alloy of at least one type selected from magnesium, aluminum, titanium, chromium, manganese, iron, cobalt, nickel, copper, zinc, zirconium, niobium, molybdenum, tungsten, or a mixture of at least one type thereof and silicon powder, is used as silicon powder to be comprised in the slurry.

39. A process for producing a silicon carbide-based porous structure material according to claim 21, wherein a silicon alloy of at least one type selected from magnesium, aluminum, titanium, chromium, manganese, iron, cobalt, nickel, copper, zinc, zirconium, niobium, molybdenum, tungsten, or a mixture of at least one type thereof and silicon powder, is used as silicon powder to be comprised in the slurry.
